(19) United States
(12) Patent Application Publication
(10) Pub. No.: US 2005/0222987 A1
(43) Pub. Date: Oct. 6, 2005

(54) Automated detection of associations between search criteria and item categories based on collective analysis of user activity data

(76) Inventor: Eric R. Vadon, Seattle, WA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/817,554

(22) Filed: Apr. 2, 2004

(51) Int. Cl. G06F 7/00

(52) U.S. Cl. 707/3

(57) ABSTRACT

A web site or other database access system provides access to a database in which items are arranged within item categories, such as browse categories of a hierarchical browse tree. Actions of users of the system are monitored and recorded to generate user activity data reflective of searches, item selection actions, and possibly other types of actions. A correlation analysis component collectively analyses the user activity to automatically identify associations between specific search criteria, such as specific search strings, and specific item categories. The results of the analysis are stored in a mapping table that is used to suggest specific item categories on search results pages.

### BACKGROUND OF THE INVENTION

1. Field of the Invention

The present invention relates to data mining algorithms for detecting associations between search criteria and item categories or attributes. The results of the analysis may, for example, be used to select item categories or groupings to suggest to a user based on search criteria supplied by the user.

2. Description of the Related Art

Web sites that provide access to databases of items commonly include a hierarchical browse structure or “browse tree” in which the items are arranged within a hierarchy of item categories. The lowest level categories contain the items themselves, while categories at higher levels contain other categories. The items arranged within the browse tree may include, for example, products that are available to purchase or rent, files that are available for download, other web sites, movies, auctions, classified ads, businesses, or any combination thereof.

Some web sites direct users to specific categories of their browse trees based on search queries submitted by users. For example, if a user submits the search query “laptop computer,” the search results page may include a link to an associated browse tree category such as “portable computers” or “laptop and notebook computers.” To implement this feature, an operator of the web site typically generates a look-up table that maps specific search strings to the item categories believed to be the most closely associated with such search strings. The task of manually generating these mappings, however, tends to be very tedious and time consuming, especially if the browse tree is very large (e.g., many hundreds or thousands of categories and many thousands or millions of items). In addition, because the mappings are typically based on the web site operator's perception of which categories are the most closely related to specific search strings, the mappings tend to be inaccurate.

### SUMMARY OF THE INVENTION

The present invention provides a system and associated methods for automatically detecting associations between specific sets of search criteria, such as search strings, and specific item categories or attributes. The invention may be embodied within a web site or other database access system that provides access to a database in which items are arranged or arrange-able within item categories, such as but not limited to browse categories of a hierarchical browse structure. The items may, for example, include web sites and pages, physical products, downloadable content, and other types of items that can be represented within a database and organized into categories. The detected associations are preferably used to suggest specific item categories to users on search results pages.

In a preferred embodiment, actions of users of the system are monitored over time to generate user activity data reflective of searches, item selection actions, and possibly other types of user actions. A correlation analysis component collectively analyses the user activity data to automatically identify associations between specific search criteria and specific item categories or attributes. For example, the correlation analysis component may treat a particular search string and a particular item category as related if a relatively large percentage of the users who submitted the search string also selected an item falling with the particular item category. Any one or more different types of item selection actions (item viewing events, purchases, downloads, etc.) may be taken into consideration in performing the analysis. In addition, the analysis may take into consideration whether a user's selection of an item was likely the result of a particular search performed by the user.

Neither this summary nor the following detailed description purports to define the invention. The invention is defined by the claims.

### BRIEF DESCRIPTION OF THE DRAWINGS

FIG. 1 illustrates a web site system according to one embodiment of the invention.

FIG. 2 illustrates a process for analyzing user activity data to detect associations between search strings and item categories.

FIG. 3 illustrates a process by which a search results page may be supplemented with related category information read from the mapping table of FIG. 1.

FIGS. 4 and 5 illustrate example search results pages that include links for accessing related item categories.

### DETAILED DESCRIPTION OF THE PREFERRED EMBODIMENTS

A specific embodiment of the invention will now be described with reference to the drawings. This embodiment is intended to illustrate, and not limit, the present invention. The scope of the invention is defined by the claims.

I. System Overview

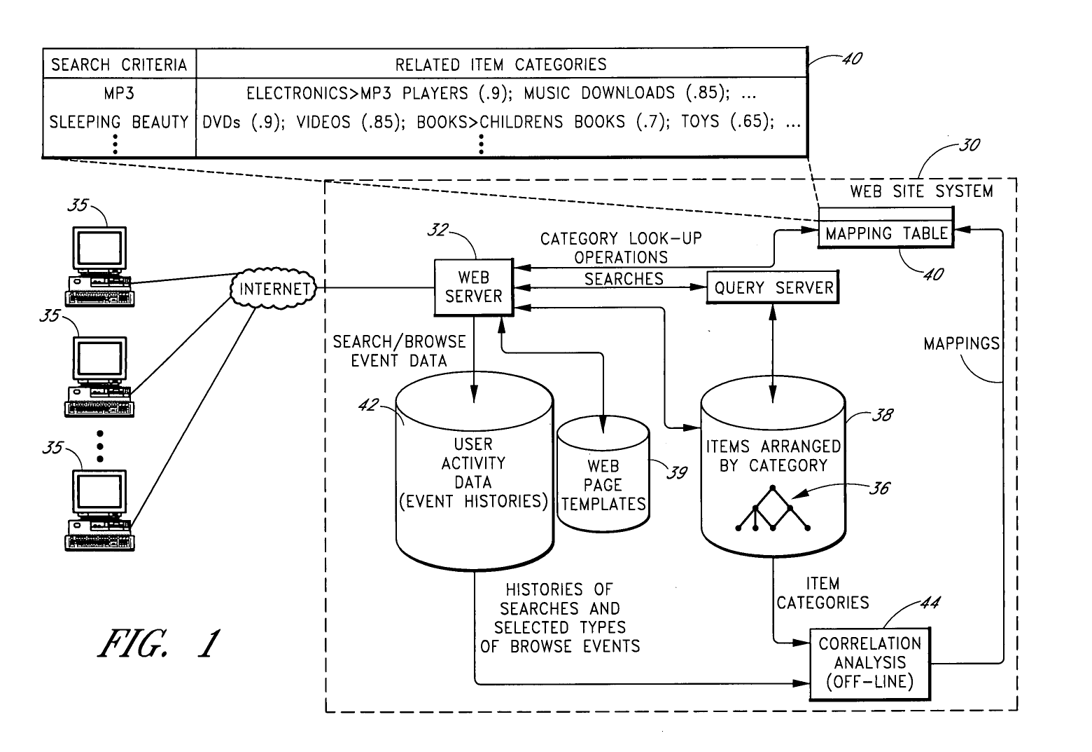

FIG. 1 illustrates a web site system 30 according to one embodiment of the invention. The web site system 30 includes a web server 32 that generates and serves pages of a host web site to computing devices 35 of end users. The web site provides user access to a database 35 containing representations of items that are arranged within a plurality of item categories. A web site is one type of database access system in which the invention may be embodied; other types of database access systems, including those based on proprietary protocols, may also be used.

The items included or represented in the database 35 may, for example, include physical products that can be purchased or rented, digital products journal articles, news articles, music files, video files, software products, etc.) that can be purchased and/or downloaded by users, web sites represented in an index or directory, subscriptions, and other types of items that can be stored or represented in a database. Many millions of different items and many hundreds or thousands of different item categories may be represented within the item database 35. Although a single item database 35 is shown, the database 35 may be implemented as a collection of distinct databases, each of which may store information about different types or categories of items.

The item categories preferably include or consist of browse categories used to facilitate navigation of an electronic catalog of items. For example, as depicted in FIG. 1, the items are preferably arranged in a hierarchical browse structure 36, commonly referred to as a “browse tree,” that includes multiple levels of browse categories (e.g., electronics>audio>portable audio>mp3 players). The browse tree 36 need not actually be “tree” in the technical sense, as a given item may fall within two or more bottom-level categories. Users of the web site system 30 can preferably navigate the browse tree 36 by selecting specific item categories and subcategories to locate and select specific items of interest. Users may additionally or alternatively browse the database using a non-hierarchical arrangement of item categories, such as an arrangement in which the items are arranged solely by brand, author, artist, genre or other item attribute.

As depicted by the query server 38 in FIG. 1, the web site system 30 also includes a search engine that allows users to search the item database 35 by entering and submitting search queries. To formulate a search query, a user types or otherwise enters a search string, which may include one or more search terms or “keywords,” into a search box of a search page served by the web server 32. The search interface may also provide an option for the user to limit the search to a particular top-level browse category, or to another collection of items. In addition, the search interface may support the ability for users to conduct field-restricted searches in which search strings are entered into search boxes associated with specific database fields (author, artist, actor, subject, title, abstract, reviews, etc.).

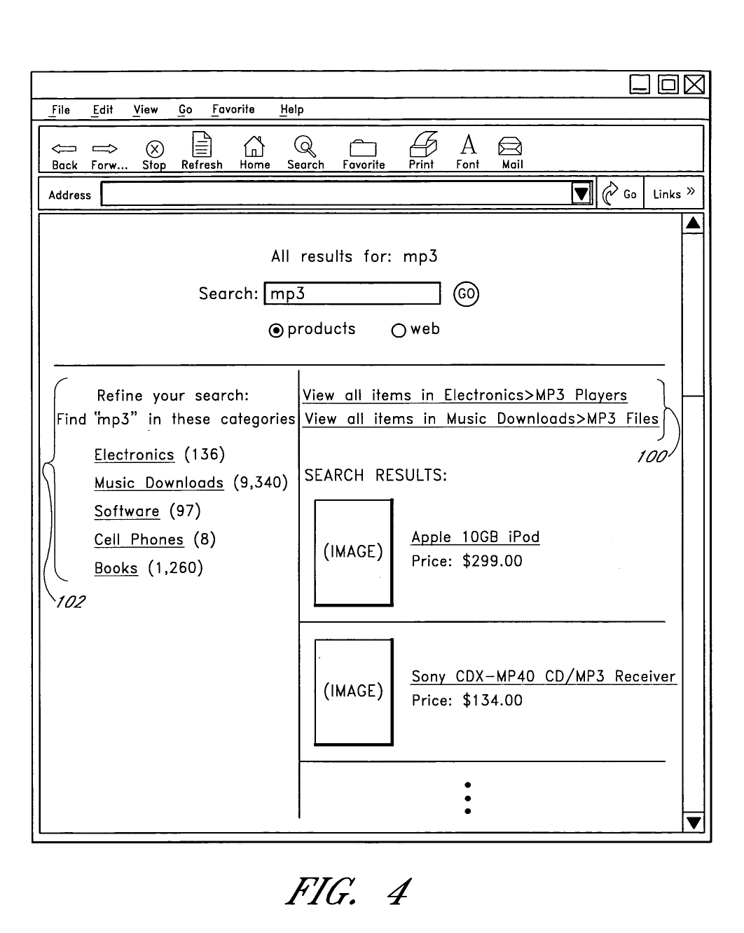

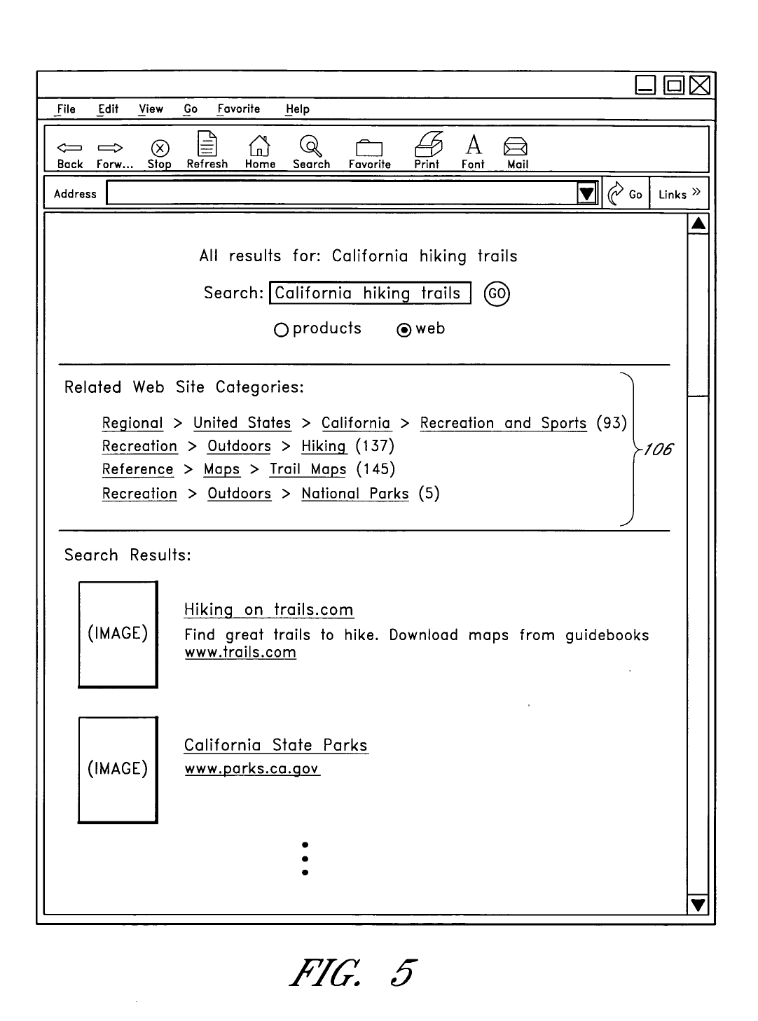

When a user submits a search query, the web server 32 passes the search query to the query server 38, which generates and returns a list of the items that are responsive to the search query. As is conventional, the query server 38 may use a keyword index (not shown) to search the item database 35 for responsive items. In addition to obtaining the list of responsive items, the web server 32 accesses a mapping table 40 that maps specific sets of search criteria, such as specific search terms and/or search phrases, to the item categories most closely related to such search criteria. If a matching table entry is found, the web server 32 displays some or all of the related item categories on the search results page together with the responsive items (see FIGS. 4 and 5, discussed below). An important aspect of the invention involves the process by which the mapping table 40 is generated, as discussed below.

In the preferred embodiment, when a user selects an item on a search results page or a browse node page (i.e., a category page of the browse tree 36), the web server 32 returns an item detail page (not shown) for the selected item. The item detail page includes detailed information about the item, such as a picture and description of the item, a price, and/or user reviews of the item. The item detail page may also include links for performing such selection actions as adding the item to a personal shopping cart or wish list, purchasing the item, downloading the items, and/or submitting a rating or review of the item. The web server 32 preferably generates the various pages of the web site, including the item detail pages, search results pages, and browse node pages, using templates stored in a database of web page templates 39.

II. Automated Detection of Associations between Search Criteria and Item Categories

An important aspect of the system 30 is that the search criteria/item category associations reflected in the mapping table 40 are detected automatically by collectively analyzing user activity data reflective of search query submissions and item selection actions performed by a population of users, which may include many thousands or millions of users. This is accomplished in part by maintaining a database 42 or other repository of user activity data reflective of search query submissions and item selection actions performed by users of the system.

To detect correlations between specific search criteria and item categories, a correlation analysis component 44 periodically analyzes sets or segments of this user activity data to search for correlations. For example, the correlation component 44 may treat the search string “Java” and the item category “books>computer languages” as being related if a large percentage of the users who searched for “Java” within a given time period also selected an item falling with the books>computer languages category within this same time period. The analysis may also take into consideration the categories explicitly selected by users during navigation of the browse tree. For example, the correlation analysis may detect that a large percentage of the users who searched for “socks” also selected the brand-based category “apparel>Foot Locker,” and treat the two as related as a result. The correlation analysis component 44 may be implemented as a program that is executed periodically by an off-line computer system.

The use of an automated computer process to detect the search criteria/item category associations provides a number of important benefits. One such benefit is that mappings for many thousands of different sets of search criteria can be generated with very little or no human intervention. For example, mappings may be generated for each of the 5K (5×1024) or 10K most commonly entered search strings. Another benefit is that the mappings tend to be very accurate, as they reflect the actual browsing patterns of a large number of users. An additional benefit is that the mappings can evolve automatically over time as new items and item categories are added to the database 35, and as search and browsing patterns of users change.

As depicted in FIG. 1, the user activity database 42 stores histories of events reported by the web server 32. The events included within the event histories preferably include both search query submissions (submissions of search criteria) and item selection actions (including item selection actions performed during category-based browsing of the database 35). The event data recorded for each search query submission event may, for example, include the search string (search term or phrase) submitted by the user, an ID of the user or user session, an event time stamp, and if applicable, an indication of the collection(s) or type(s) of items searched. If field-restricted searching is supported, the event data may also identify the specific database field or fields that were searched (e.g., title, author, subject, etc.).

The event data recorded for an item selection action may, for example, include the ID of the selected item, an ID of the user or user session, and an event time stamp. Other types of item-selection event data that may be recorded, and used to detect the associations, may include the following: the type of selection action performed (e.g., selection of item for viewing, selection of item to download, shopping cart add, purchase, submission of review or rating, etc.), and the type of page from which the item selection was made (e.g., search results page, browse node page, etc.). The type or types of item selection actions that are recorded within the user activity database 42 and used to detect the associations may vary depending upon the nature of the web site (e.g., web search engine site, retail sales site, digital library, music download site, product reviews site, etc.). If multiple different types of item selection actions are recorded, the correlation analysis component 44 may optionally accord different weights to different types of selection actions. In addition to item selection events, other types of events, such as category selection events, may be recorded within the user activity database 42 and used to detect the associations.

The event histories may be stored within the user activity database 42 in any of a variety of possible formats. For example, the web server 32 may simply maintain a chronological access log that describes some or all of the client requests it receives. A most recent set of entries in this access log may periodically be retrieved by the correlation analysis component 44 and parsed for analysis. Alternatively, the event data may be written to a database system that supports the ability to retrieve event data by user, event type, event date and time, and/or other criteria; one example of such a system is described in U.S. patent application Ser. No. 10/612,395, filed Jul. 2, 2003, the disclosure of which is hereby incorporated by reference. Further, different databases and data formats may be used to store information about different types of events (e.g., search query submissions versus item selection actions).

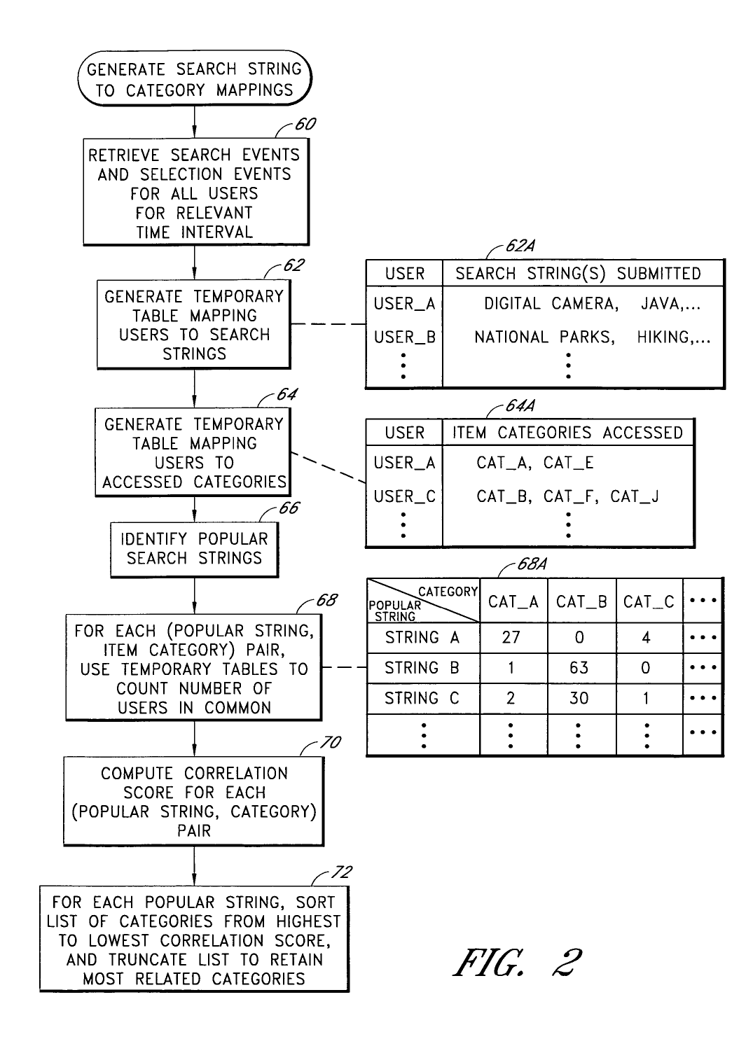

For purposes of analysis, the user activity data (event histories) stored in the database 42 may be divided into segments, each of which corresponds to a particular interval of time such as one day or one hour. The correlation analysis component 44 may analyze each such segment of activity data separately from the others. The results of these separate analyses may be combined to generate the mappings reflected in the mapping table 40, optionally discounting or disregarding the results of less recent segments of activity data. For example, correlation results files for the last X days (e.g., two weeks) of user activity data may be combined to generate a current set of mappings, and this set of mappings may be used until the next segment of user activity data is processed to generate new mappings. An example of an algorithm that may be used to analyze the user activity data is depicted in FIG. 2 and is described below. Each time the correlation analysis component 44 processes a new block of activity data, it either updates or regenerates the mapping table 40 to reflect the latest user activity.

Each entry in the mapping table 40 maps a specific set of search criteria, such as a specific search term or search phrase, to a list of the N item categories that are the most closely related to that set of search criteria, where N is a selected number such as ten, twenty or fifty. (A “set” of search criteria, as used herein, can consist of a single element of search criteria, such as a single search term.) For each category in this list, the table may also include a “correlation score” that indicates a degree to which the category is associated with the corresponding set of search criteria. In the illustrated example, the scores can range from 0 to 1, with a score of “0” indicating a minimal degree of correlation and a score of “1” indicating a maximum degree of correlation. The first sample table entry shown in FIG. 1 indicates that the search string “MP3” is more closely related to the item category “MP3 Players” than to the item category “Music Downloads.”

The mapping table 40 may, for example, include a separate entry for each of the M (e.g., 5K or 10K) search strings that were used the most frequently over a selected period of time. Search strings that are highly similar, such as those that are identical when capitalization, noise words (“a,” “the,” “an,” etc.), and punctuation variations are ignored, may be treated as the same search string for purposes of generating the table 40. The mapping table 40 may be implemented using any type of data structure, or combination of data structures, that permits efficient look-up of categories. One example of a type of data structure that may be used is a hash table

Although the mapping table 40 depicted in FIG. 1 exclusively maps search strings to item categories, a table that maps more generalized sets of search criteria to item categories, including search criteria that identifies the type of the search, may alternatively be used. For instance, the mapping table 40 may include entries that correspond to specific types of field-restricted searches, such as title searches, subject searches, or author searches. Thus, for example, one table entry may map the search criteria set [title search for “Ford”] to one set of item categories, and another table entry may map the search criteria set [author search for “Ford”] to a different set of item categories. As another example, mapping table entries may be included that correspond to specific collections of items searched (e.g., products search, literature search, web search, etc.). Further, different mapping tables 40 may be generated and used for different types of searches (e.g., web search, product search, title search, etc.).

It should be noted that the item categories included in the mappings need not consist of browse categories that are ordinarily used to browse the catalog of items, but rather may include specific item attributes that may be used to form a grouping of items. For instance, a particular search string may be mapped to a particular product brand (one example of a product attribute), even though the web site's browse interface does not support browsing of the catalog by brand. Thus, for example, when a user searches for “PDA,” the user may be given an option to view all products from “Palm” and “Mindspring,” even if the system's browse tree does not include links for either of these brands. Accordingly, any group of items that share a common attribute (e.g., author=Clark) may be treated as an item category for purposes of implementing the invention. In this regard, a category may be represented within the mapping table 40 as a particular attribute (e.g., brand=Sony) or attribute set (e.g., type=video and rating=G), rather than by a category name or ID.

FIG. 2 illustrates one example of an algorithm that may be used by the correlation analysis component 44 to detect associations between search strings and item categories. As will be apparent, numerous variations to this algorithm are possible, a few of which are discussed below. In block 60, the correlation analysis component 44 retrieves from the user activity database 42 the event data for search events and selection events (which may include both item and category selection events) for all users over the relevant time interval. The time interval may, for example, be the last one, twelve, or twenty four hours. In block 62, the retrieved search event data is used to generate a temporary table 62A that maps users to the search strings submitted by such users. In embodiments in which other types of search criteria are also reflected in the mappings, this table 62A may map users to more generalized sets of search criteria (e.g., to entire search queries, which may include field restrictions, collection searched, etc.).

In block 64, the retrieved selection event data is used to generate a temporary table 64A that maps users to the item categories “accessed” by such users. For purposes of generating this table, a selection of an item that falls within a given category may be treated as an access to that category. The type or types of item selection actions taken into consideration in determining whether a user “accessed” a given category is a matter of design choice, and may vary depending on the type of items involved. For instance, for a category of merchandise items, the category may be treated as accessed if the user purchased, added to a shopping cart, added to a wish list, or even viewed an item falling within that category. For a category of web sites listed in a web site directory, the category may be treated as accessed if, for example, the user selected a link within the directory to access a web site within that category. For a category of news or journal articles, the category may be treated as accessed if, for example, the user viewed or downloaded the full text of an article within that category. For browse categories, a category may also optionally be treated as accessed if the user selected the category itself during navigation of a browse tree to view a corresponding category page; in this regard, a browse category may, in some embodiments, be treated as accessed only if the user actually selected the browse category itself.

In block 66, the temporary search string table 62A is used to identify search strings that are “popular.” A given search string may be treated as popular if, for example, it was submitted by more than a selected threshold of users (e.g., ten) over the relevant time interval. In block 68, the temporary tables 62A, 64A are used to count, for each (popular search string, item category) pair, the number of users in common (i.e., the number that both submitted the string and accessed the category during the relevant time period). The results of this task are depicted by the preliminary mapping table 68A in FIG. 2. In this example, the table 68A reveals that of the users who submitted string A, twenty seven also accessed category A, zero accessed category B, and so on. Although not illustrated in FIG. 2, the correlation data represented by this table 68A may optionally be merged with correlation data from prior iterations/time intervals before proceeding to the next step.

In block 70, a correlation score is calculated for each (popular string, item category) pair. The equation shown below may be used for this purpose, in which “CS” stands for “correlation score:”
CS(string, category)=C/SQRT(A·B)
where:
A=number of users that submitted the string,
B=number of users that accessed the category, and
C=number of users that both submitted string and accessed the category.

The correlation score is a measure of the degree to which the particular search string and item category are related. Any of a variety of other equations or algorithms may be used to calculate the correlation scores. The following are examples:

Cosine Method:
CS(string, category)=C/SQRT(A·B)
where:
A=number of users that submitted the string,
B=number of users that accessed the category, and
C=number of users that both submitted string and accessed the category.

Relative Risk Method:
CS=(A/B)/(C/D)
where:
A=number of users that both submitted string and accessed the category,
B=number of users that submitted string
C=number of users that did not submit the string and accessed the category
D=number of users that did not submit the string

Odds Ratio Method:
CS=(A/C)/(E/F)
where:
A=number of users that both submitted string and accessed the category,
C=number of users that did not submit the string and accessed the category
E=number of users that submitted the string but did not access the category
F=number of users that did not submit the string and did not access the category

Probability Lift Method:
alpha=32*log(frequency-of-use rank of B)−84
CS=C/B−(alpha)*A/D
where:
A=number of users that accessed the category
B=number of users that submitted the string,
C=number of users that both submitted the string and accessed the category
D=Total number of users who have accessed any category and have made any search
w is a weighting factor such as 0.20.

Weighted method: The above mentioned scores can be combined in a variety of ways to produce a weighted average of multiple scores. For example:
ΣWᵢCSᵢ
where W is a weighting function for each correlation score, CS is the correlation score itself, and ΣWᵢ=1. For example, we could combine the Cosine and Probability List methods as follows:
CS=w(Cosine Method)+(1−w)*(Probability Lift Method)
where w is a weighting factor such as 0.20.

In block 72, for each popular string, the list of categories (CAT_A, CAT_B, CAT_C . . . ) is sorted from highest to correlation score, or equivalently, for highest to lowest degree of association with the particular search string. In addition, each such list of categories is truncated to a fixed maximum length (e.g. ten categories), so that only those categories most closely related to the particular search string are retained in each list. The result of block 72 is a set of string-to-category mappings of the form shown in FIG. 1 (table 40 in exploded form). As mentioned above, the correlation score values may, but need not, be retained.

As will be apparent from the foregoing description of FIG. 2, if a user submits a particular search string and accesses a particular item category within the time interval associated with the retrieved activity data, these two events will affect the correlation score for this (search string, item category) pair. One variation to the algorithm is to take into consideration only those category access events that are deemed to be the result of, or closely associated with, the search string submission. For instance, in this example, the category access event may be excluded from consideration in calculating the correlation score for this (search string, item category) pair unless one of the following conditions is satisfied: (a) the user accessed the item category within a threshold number of clicks (e.g., 10) before or after submitting the search string; (b) the user accessed the item category within a threshold amount of time (e.g., 3 minutes) before or after submitting the search string; or (c) the user accessed the item category after submitting the search string and before submitting a new search string.

Another variation is to limit the analysis to the detection of associations between specific search terms (keywords) and item categories. With this approach, each entry in the mapping table 40 corresponds uniquely to a specific search term. If a user submits a search query containing two or more search terms, the mapping table entries (category sets) for each of these search terms may be used in combination to identify item categories to suggest to the user, such as by taking the intersection of these category sets.

Other types of relatedness metrics may also be taken into consideration when generating the mapping table 40. For instance, the correlation data generated by analyzing the user activity data may be combined with the results of an automated content-based analysis in which the search strings are compared to item records or descriptions in the database 35. Thus, the mappings reflected in the mapping table 40 need not be based exclusively on an analysis of user activity data.

III. Use of Mapping Table to Supplement Search Results Pages

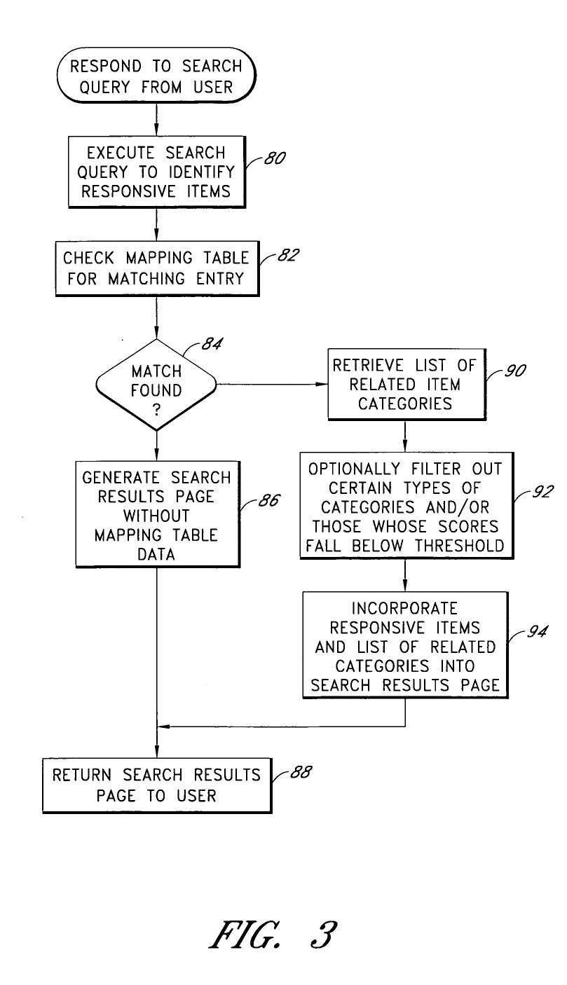

FIG. 3 illustrates one example of a sequence of steps that may be performed by the web site system 30 to process a search query from a user. In block 80, the search query is executed to identify items from the database 35 that are responsive to the search criteria supplied by the user. In blocks 82 and 84, the web server 32 accesses the mapping table 40 to determine whether a table entry exists that matches the user-supplied search criteria. In embodiments in which the mappings consist of search string to category mappings, this step is performed by determining whether a table entry exists that matches the user's search string. Minor variations between search strings, such as variations in the form of a search term (e.g., singular versus plural), may be disregarded for purposes of determining whether a match exists. If no match is found, the web server generates and returns a search results page that does not include category data read from the mapping table (blocks 86 and 88). In this event, a set of related categories may optionally be identified on-the-fly using an alternative method, such as a method that takes into consideration the number of items found within each category.

If a match is found in block 84, the associated list of item categories is retrieved from the mapping table 40. As depicted in block 90, this list may optionally be filtered to remove certain types of categories (e.g., all but top-level categories), and/or to filter out those categories having a correlation score that falls below a desired threshold. Some or all of the categories in this list are then incorporated into the search results page (block 94), together with a list of any responsive items.

FIG. 4 is an example search results page illustrating two different ways in which category data retrieved from the mapping table 40 may be incorporated into search results pages. In this example, the user has submitted the search string “mp3” to search a hierarchically-arranged catalog of products. In addition to displaying a list of the matching items (search results), the page includes two sections 100, 102 generated from the list of item categories retrieved from the mapping table for the search string “mp3.” The first section 100 includes links to the browse node pages of the bottom-level product categories most closely related to the search string. This section may be generated by filtering out from the retrieved category list all but the lowest-level browse categories (see block 92 in FIG. 3).

The second section 102 in FIG. 4 includes a link for each of the top-level product categories that are the most closely related to the search string, ordered from highest to lowest correlation score. This list may be generated by filtering out from the retrieved category list all categories except top-level browse categories. The numerical values indicate the number of matching items (products) found within each of these top-level browse categories. Selection of a link in this section 102 has the effect of narrowing the scope of the search to the products falling within the corresponding top-level category.

FIG. 5 depicts an example search results page for a web search for the string “California hiking trails.” In addition to displaying the results of the web search, the page includes a listing 106 of the bottom-level web site categories most closely related to this search string. Each link within this listing 106 points to a corresponding browse node page of a browse tree in which web sites are arranged by category. The numerical values shown in parenthesis indicate the total number of items (web sites) falling within the respective bottom-level categories.

Yet another approach, which is not illustrated in the drawings, is to arrange the search results (matching items) by item category on the search results page, with the item categories being ordered from highest to lowest degree of association with the search string. To facilitate viewing of results from multiple categories, a limited number of matching items (e.g. 3, 4 or 5) may be displayed on the search results page within each such item category.

IV. Tracking of Category Selection Actions on Search Results Pages

One optional feature of the invention is to track the frequency with which users select specific categories displayed on the search results pages. This data may be used as an additional or alternative metric to select the related categories to display on a given search results page, and/or to select the order in which these related categories are displayed. For instance, referring to FIG. 5, if a relatively large number of the users who search for “California hiking trails” select the category “Trail Maps” on the resulting search results page, this category may, over time, be elevated to the first position in the list 106. If, on the other hand, a relatively small fraction of these users select “Trail Maps,” this category may be moved to a lower position in the list 106, or may drop off the list 106 and be replaced with another related category stored in the mapping table 40.

To implement this feature, the web server 32, or a component that runs on or in conjunction with the web server 32, may store within the mapping table 40 the following information for each search string/related category pair: (a) the number of times this pair was displayed on a search result page (i.e., the number of impressions), and (b) the number of times the display of this pair resulted in user selection of the particular category (i.e., the number of clicks). The impressions and clicks values may be updated in real time as pages are served, or may be derived from an off-line analysis user activity data. Rather than storing the actual impressions and clicks counts for each search string/related category pair, the ratio of these two values may be stored, particularly if some threshold number of impressions has been reached.

When a user conducts a search, the related categories stored in the mapping table 40 for the submitted search string may be ordered/ranked for display from highest to lowest clicks-to-impressions ratio. For example, for the search string “California Hiking Trails” shown in FIG. 5, if the related category “Trail Maps” has the highest clicks/impressions ratio, this category may be displayed on the search results page at the top of the related categories list 106. Related categories with lower clicks-to-impressions ratios may be displayed lower in the list 106, or may be omitted from the list 106. Rather than selecting the display position based solely on the clicks-to-impressions ratios, a weighted approach may be used in which a category's rank or display position is also dependent upon its degree of similarity to the submitted search string, and possibly other metrics.

This feature of the invention may also be used in embodiments in which the mapping table 40 maps more generalized sets of search criteria to related categories.

Although this invention has been described in terms of certain preferred embodiments and applications, other embodiments and applications that are apparent to those of ordinary skill in the art, including embodiments which do not provide all of the features and advantages set forth herein, are also within the scope of this invention. Accordingly, the scope of the present invention is defined only by the appended claims, which are intended to be interpreted without reference to any explicit or implicit definitions that may be set forth in the incorporated-by-reference materials.

1. In a database access system that provides access to a database in which items are arranged within item categories, a method for facilitating searches for items, the method comprising:
monitoring actions performed by a plurality of users of the database access system over time to generate user activity data that identifies search criteria specified by the users to search the database of items, and identifies items selected from the database by the users;
programmatically analyzing the user activity data to identify correlations between specific sets of search criteria and specific item categories;
generating a mapping structure that maps specific sets of search criteria to specific item categories based at least in-part on the correlations identified by programmatically analyzing the user activity data; and
in response to a submission by a user of a search query that includes a set of search criteria, accessing the mapping structure to identify at least one item category that is related to the set of search criteria, and suggesting the at least one item category to the user in conjunction with results of the search query.

2. The method of claim 1, wherein the sets of search criteria consist of search strings submitted by users.

3. The method of claim 1, wherein the sets of search criteria include search strings submitted by users.

4. The method of claim 3, wherein the sets of search criteria further include field identifiers selected by the users to perform field-restricted searches.

5. The method of claim 3, wherein the sets of search criteria further include item collection identifiers selected by the users to limit searches to specific collections of items.

6. The method of claim 1, wherein programmatically analyzing the user activity data comprises generating, for a given set of search criteria and a given item category, a score that reflects a frequency with which users who submitted the given set of search criteria also selected an item falling within the given item category.

7. The method of claim 1, wherein programmatically analyzing the user activity data comprises identifying, for a given set of search criteria, which of a plurality of item categories were accessed the most frequently by users who submitted the given set of search criteria, wherein user selection of an item is treated as an access to a corresponding item category.

8. The method of claim 1, wherein programmatically analyzing the user activity data comprises taking into consideration a plurality of different types of item selection actions that are reflected in the user activity data.

9. The method of claim 8, wherein programmatically analyzing the user activity data further comprises according different weights to different types of item selection actions.

10. The method of claim 1, wherein the item categories include categories of a hierarchical browse structure that is accessible to the users.

11. The method of claim 10, wherein the correlations take into consideration item selection actions performed by users during browsing of the hierarchical browse structure.

12. The method of claim 10, wherein the correlations take into consideration browse category selection actions performed by users during browsing of the hierarchical browse structure.

13. The method of claim 1, wherein programmatically analyzing the user activity data comprises identifying, for a given search query submission event within an event history of a user, a subset of item selection events within the event history that are sufficiently proximate to the search query submission event to be treated as related to the search query submission event.

14. The method of claim 1, wherein programmatically analyzing the user activity data comprises dividing the user activity data into a plurality of segments that correspond to specific time intervals, analyzing the segments separately from one another to generate multiple correlation result sets, and combining the multiple correlation result sets.

15. The method of claim 1, wherein suggesting the at least one item category to the user comprises displaying, on a search results page, a link to page that corresponds to the item category.

16. The method of claim 1, wherein at least some of the categories represented within the mapping structure are represented in terms of item attributes used to categorize items.

17. A system for detecting associations between sets of search criteria and categories of items, the system comprising:
a server system that provides browsable and searchable access to an electronic catalog of items;
a monitoring component that monitors and records search query submissions and selection actions of users of the electronic catalog to generate user activity data; and
an analysis component that collectively analyzes the user activity data associated with a plurality of users to identify associations between specific sets of search criteria and specific item categories.

18. The system of claim 17, wherein the sets of search criteria consist of search strings submitted by users.

19. The system of claim 17, wherein the sets of search criteria include search strings submitted by users.

20. The system of claim 17, wherein the analysis component generates, for a given set of search criteria and a given item category, a score that reflects a frequency with which users who submitted the given set of search criteria also selected an item falling within the given item category.

21. The system of claim 17, wherein the analysis component identifies, for a given set of search criteria, which of a plurality of item categories were accessed the most frequently by users who submitted the given set of search criteria, wherein user selection of an item is treated as an access to a corresponding item category.

22. The system of claim 17, wherein the analysis component takes into consideration a plurality of different types of item selection actions that are reflected in the user activity data.

23. The system of claim 17, wherein the item categories include browse categories of a hierarchical browse structure of the electronic catalog.

24. The system of claim 23, wherein the associations identified by the analysis component reflect item selection actions performed by users during browsing of the hierarchical browse structure.

25. The system of claim 23, wherein the associations identified by the analysis component reflect browse category selection actions performed by users during browsing of a hierarchical browse structure of the electronic catalog.

26. The system of claim 17, wherein the analysis component identifies, for a given search query submission event within an event-history of a user, a subset of item selection events within the event history that are sufficiently proximate to the search query submission event to be treated as related to the search query submission event.

27. The system of claim 17, wherein the analysis component divides the user activity data into a plurality of segments that correspond to specific time intervals, analyzes the segments separately from one another to generate multiple correlation result sets, and combines the multiple correlation result sets.

28. The system of claim 17, wherein the server system uses the associations identified by the analysis component to select item categories to display on search results pages.

29. A method of processing query submissions, comprising:
receiving a user submission of a set of search criteria for searching a database of items;
identifying a set of items within the database that are responsive to the set of search criteria;
accessing a mapping structure to look up at least one item category that, based on an automated analysis of user event histories, has been accessed relatively frequently by users who have previously submitted the set of search criteria; and
responding to the user submission by generating and returning a search results page that lists the responsive items and the at least one item category.

30. The method of claim 29, wherein the set if search criteria comprises a search term.

31. The method of claim 30, wherein the set if search criteria additionally comprises at least one of the following: (a) an identification of a search field for performing a field-restricted search; (b) an identification of a collection of items to be searched.

32. The method of claim 29, wherein the set of search criteria comprises a plurality of search terms.

33. The method of claim 29, wherein the set if search criteria consists of a single search term.
